(19) United States
(12) Patent Application Publication
(10) Pub. No.: US 2010/0263204 A1
(43) Pub. Date: Oct. 21, 2010

(54) HIGH TEMPERATURE COMPOSITE TAPE AND METHOD FOR MANUFACTURING THE SAME

(76) Inventors: Xuan Wu, Shanghai (CN); Hai Kun Xiong, Shanghai (CN)

Correspondence Address: 3M INNOVATIVE PROPERTIES COMPANY, PO BOX 33427, ST. PAUL, MN, 55133-3427, US

(21) Appl. No.: 12/746,956

(22) PCT Filed: Nov. 26, 2008
(86) PCT No.: PCT/US08/84808

§ 371 Date: Jun. 9, 2010

(30) Foreign Application Priority Data
Dec. 14, 2007 (CN) 200710300962.9

(51) Int. Cl. H01R 43/00; B32B 37/02; B32B 7/12

(52) U.S. Cl. 29/825; 156/60; 428/352

(57) ABSTRACT

A method of manufacturing a composite tape used for producing printed circuit board is provided. The method includes the steps of: providing a mold-releasing layer on a first surface of a paper substrate layer; providing a composite adhesive layer on a second surface of the paper substrate layer, the composite adhesive layer being formed by polyurethane adhesive, polyester adhesive, or a mixture thereof; providing a plastic layer on a second surface of the composite adhesive layer; and providing an adhering layer on a second surface of the plastic layer. The composite tape according to the invention can not only bear high temperature up to 280° C. for a predetermined time, but also the tape does not detach or warp.

### FIELD OF INVENTION

The invention relates to a tape and a method for manufacturing the same, especially to a high temperature composite tape for a printed circuit board and a method for manufacturing the same.

### BACKGROUND OF INVENTION

Conventionally, during the manufacturing process of an electric device such as a printed circuit board (PCB), a certain area in the printed circuit board needs to be coated with tin whereas the remaining area on the printed circuit board needs to be covered by a shielding member such as a protecting tape. The printed circuit board needs to be tinned for a short time under high temperature during the manufacturing process.

Existing protecting tapes typically adopt rubber type glue as composite adhesive. However, the disadvantage of the rubber type glue is that it can not bear temperature higher than 260° C. Thus, in the manufacturing process of the printed circuit board, such as after high temperature processing of blast heat leveling, paper functioning as the substrate material may be separated from the PET. Further, the appropriate bonding strength can be achieved only when the existing rubber type glue reaches to a certain thickness. However, this may yield a final tape thickness that is too thick. Therefore, tin may seep during the blast heat leveling, wave soldering etc., and accumulate at the bonding edge of the tape with the PCB, leading to “tin dam” phenomena. The currently used tinning process during the blast heat leveling contains lead. With the requirement of environment protection, the lead-containing process is progressively substituted by lead-free process. The important difference between the lead containing process and the lead-free process lies in that the temperature during lead-free process may reach 280° C. or higher whereas the temperature during lead containing process usually reaches 250°-260° C. The existing tape can not satisfy this elevated temperature requirement.

To this end, some patents have been put forward to solve the above problem. For example, TW487727 published on Jun. 2, 1998, Taiwan, China discloses a high temperature protecting tape, in which a metal film layer is incorporated in the tape. During high temperature process, the metal film layer is uniformly heated, so that the warpage at the edge of the tape is avoided, and tin seeping may occur accordingly. However, the addition of the metal film layer leads to increasing of tape thickness, which also increases the possibility of the tin accumulating at the bonding edge of the tape with the PCB. And because the thermal expansion coefficient of metal is relatively large as compared to paper and metal film layer, this difference may lead to the warpage of the entire tape substrate material.

In addition, product numbers CM8R and CM8G high temperature shielding paper-plastic composite tape manufactured by Four Dimension Tape Corp. use the rubber type glue as the composite adhesive, which products may endure highest temperature of about 250° C. for 1 minute. Product number 657 blast heat leveling tape manufactured by Scapa Corp. has the highest temperature of about 105° C.

### SUMMARY OF INVENTION

From above, existing commercially available tapes can not solve the elevated temperature issues. There is a need for a thin high temperature shielding tape that can endure 280° C. or higher for 2 minutes in the market, in which the paper-plastic composite substrate material does not detach or warp.

In one aspect, the present disclosure provides a composite high temperature tape and a method for manufacturing the same. Even if the composite tape disclosed herein is subject to high temperature up to 280° C. for 2 minutes, paper-plastic composite substrate material thereof may substantially not detach, and the composite high temperature tape will remain substantially flat.

In another aspect, the present disclosure provides a high temperature composite tape and a method for manufacturing the same. The high temperature composite tape can reduce tin accumulation at a bonding edge of the high temperature composite tape with the PCB plate.

In yet another aspect, the present disclosure provides a manufacturing method for a printed circuit board using the high temperature composite tape disclosed herein.

To achieve the various aspects of this disclosure, a method of manufacturing a composite tape the steps of which may be used for producing printed circuit board, is provided. The method comprises providing a mold-releasing layer on a first side of a paper substrate layer; providing a composite adhesive layer on an opposing second side of the paper substrate layer, the composite adhesive layer being formed by polyurethane adhesive, polyester adhesive, or the mixture thereof; providing a plastic layer on a lower side of the composite adhesive layer; and providing an adhering layer on a lower side of the plastic layer.

In yet another aspect of the present disclosure, a composite tape used for manufacturing a printed circuit board is provided. The composite tape comprises a paper substrate layer; a mold-releasing layer provided on a first surface of a paper substrate layer; a composite adhesive layer provided on an opposing second surface of the paper substrate layer, the composite adhesive layer comprising polyurethane adhesive, polyester adhesive, or a mixture thereof; a plastic layer provided on a second surface of the composite adhesive layer; and an adhering layer provided on a second surface of the plastic layer.

In yet another aspect of the present disclosure, a manufacturing method for a printed circuit board is provided. The method includes adhering a composite tape disclosed herein to an area to be protected on a printed circuit board; tinning the printed circuit board by transferring; and flatting the printed circuit board taken out under hot blast air.

Compared with the existing tapes, the composite tape according to the present disclosure has one or more of the following advantages. Because the composite adhesive layer is formed by polyurethane adhesive, polyester adhesive, or the mixture thereof, the composite tape can endure temperature exposure of 280° C. or higher. The paper-plastic composite substrate material does not detach or warp. Furthermore, due to the composite adhesive layer, the thickness of the substrate material can be reduced, thus reducing the accumulation of the tin or other metals.

### BRIEF DESCRIPTION OF THE DRAWING

The present invention will be further described with reference to the accompanying drawings, wherein:

FIG. 1 shows a cross-sectional view of the composite tape according to the present disclosure;

FIG. 2 shows the flow diagram of a method of manufacturing a composite tape according to the present disclosure; and

FIG. 3 shows the flow diagram of the method for manufacturing a printed circuit board according to the present disclosure.

Additional objects, advantages and aspect of the present invention will be more readily apparent for those skilled in the art guided by the following detailed description of preferred embodiment when taken together with accompanying drawings. The accompanying drawings and various embodiment are not drawn to scale and intended for explanation purpose.

### DETAILED DESCRIPTION OF EMBODIMENTS

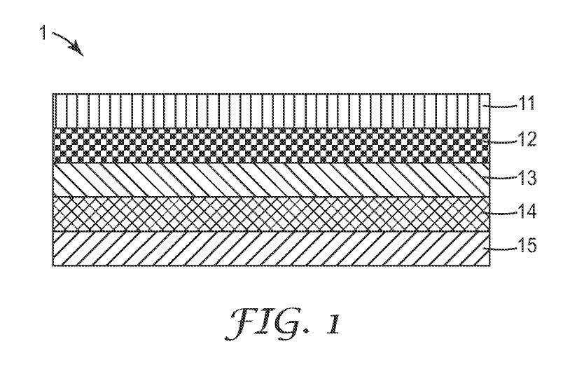

FIG. 1 shows the cross-sectional view of a composite tape that can be used as a high temperature shielding member during the manufacturing process of electric or electronic devices. In particular the high temperature composite tape 1 can be used for providing high temperature protection for partial area on a printed circuit board during its manufacturing. Normally, during the manufacturing process of a printed circuit board, a high temperature resistant protecting tape is needed. The tape can protect gold fingers from being tinned or inserting holes being jammed on the printed circuit board during the tinning of the printed circuit board. Thus, tin or solder would not lead to electrical conduction or inserting hole jam. In addition, the high temperature composite tape 1 would not be detached during manufacturing process under tinning, blast heat flatting and wave soldering conditions. Meanwhile, the tape can be peeled easily with substantially free of residual adhesive.

As shown in FIG. 1, the composite tape 1 for manufacturing the printed circuit board has 5 layers, a paper substrate layer 12, a mold-releasing layer 11, a composite adhesive layer 13, a plastic layer 14 and an adhering layer 15. Normally, the paper substrate layer 12 has opposing first and second sides and is made of flat paper, black back paper or crept paper. The mold-releasing layer 11 provided on the first side of the paper substrate layer 12, can be the acrylic acid or florin-containing one. The mold-releasing layer can be the acrylic acid emulsion or one that can mold-release the organic silicon pressure sensitive adhesive.

The composite adhesive layer 13 is provided on the second side of the paper substrate layer. The composite adhesive layer 13 comprises polyurethane adhesive, polyester adhesive, or the mixture thereof, which can withstand temperature as high as 280° C. In one exemplary embodiment, the composite adhesive can be ADCOTE 76P1-38, manufactured by ROHM&HASS. With the use of high temperature resistant polyester, polyurethane type adhesives, the thickness of the composite adhesive layer 13 is reduced while the bonding strength thereof is maintained.

The plastic layer 14 is disposed on the composite adhesive layer 13. Suitable plastic layer 14 includes but is not limited to polyethylene terephthalate (PET), polybutylene terephthalate (PBT), polyimide (PI), polyethylene naphthalate (PEN). Preferably, the plastic layer 14 can be processed by corona processing to increase surface energy of the plastic layer. The adhering layer 15 is disposed on the plastic layer 14. The adhering layer 15 can be made of organic silicone pressure-sensitive adhesive or those having similar chemical properties.

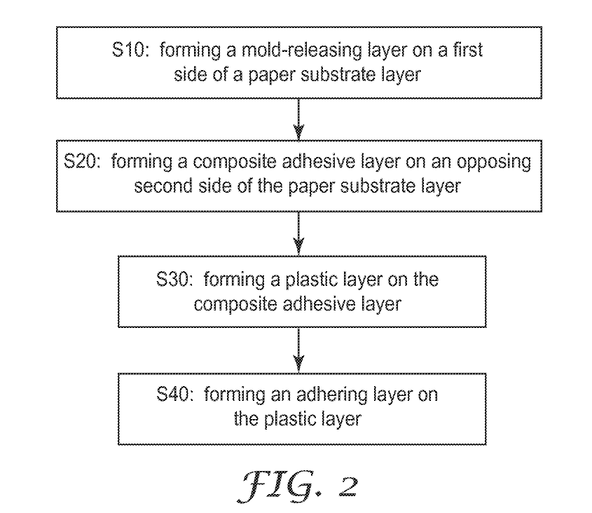

FIG. 2 shows the flow diagram of a method of manufacturing a composite tape. Firstly, a mold-releasing layer 11 is formed on a first side of the paper substrate layer 12 (S10). Secondly, the composite adhesive layer 13 made of polyurethane adhesive, polyester adhesive, or the mixture thereof is provided on an opposing second side of the paper substrate layer 12 (S20). Then, the plastic layer 14 is formed the composite adhesive layer 13 (S30). Finally, the adhering layer 15 is provided on the plastic layer 14 (S40). It should be noted that the above steps are described only for illustration purpose. Variations of the process shown in FIG. 2 can be used. For example, the paper substrate layer 12 and the mold-releasing layer 11 can be formed in a first stack. Then the composite adhesive layer 13, the plastic layer 14 and the adhering layer 15 can be formed in a second stack. The two stacks are attached together, resulting in the composite tape 1. Other step combinations are also possible for making the composite tape.

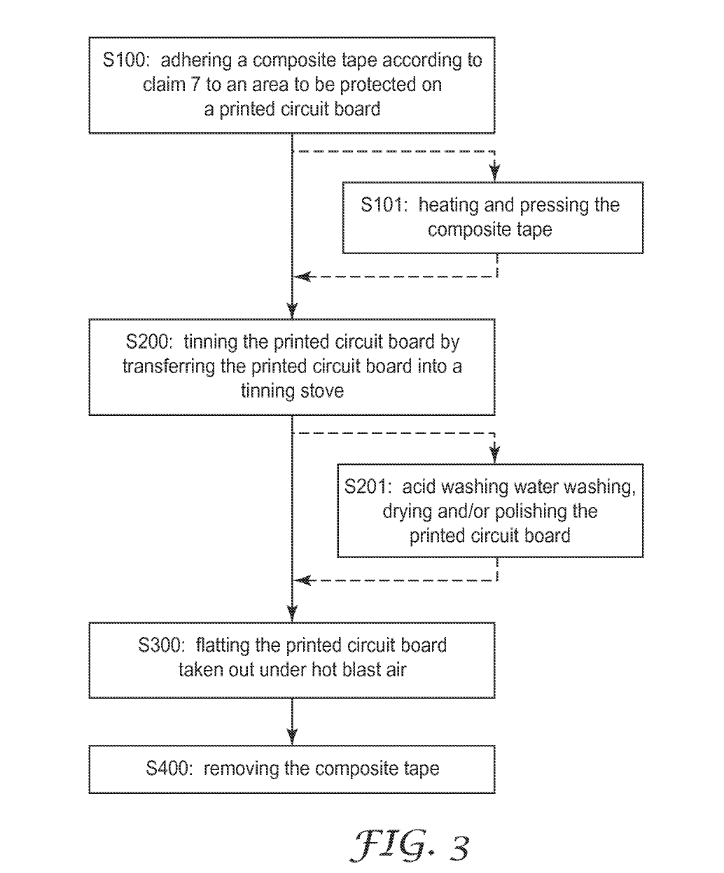

FIG. 3 shows the flow diagram of a method for manufacturing a printed circuit board according to one embodiment of the present disclosure.

In the manufacturing process of the printed circuit board, the surface thereof needs to be tinned. If required, the surface of the printed circuit board can be polished. For this end, the areas where tinning is not required on the printed circuit board, such as gold fingers or gold coating areas on the surface of the printed circuit board, have to be shielded. The high temperature composite tape 1 disclosed herein can be used for this purpose. Then, the printed circuit board can be transferred into high temperature tinning stove for tinning Because the temperature in the tinning stove can reach 280° C. or higher, the composite tape disclosed herein can withstand temperature as high as in the stove, in addition to not detaching and not warping. After tinning, the residual tin on the surface of the printed circuit board can optionally be blown off using high speed and high temperature gas. Prior art tape can be thick, which may bring up the phenomena of “tin dam” at the bonding edges of the tape with the printed circuit board. In addition, acid washing, water washing, drying and/or polishing may be performed before or after the tinning step, as process may require, so that the tin can be securely coated on the surface of the printed circuit board.

A manufacturing method for a printed circuit board of one embodiment comprises the following steps. The composite tape 1 disclosed herein is adhered to an area to be protected on a printed circuit board (S100). Alternatively, the composite tape may be heated and pressed after this step, as shown in (S101). The printed circuit board adhered with the composite tape 1 is transferred into a tinning stove for PCB tinning (S200). Alternatively, the printed circuit board may be acid washed, water washed, drying and/or polished before and/or after the tinning step, as shown in (S201). Then, the printed circuit board is taken out and flattened under hot air blast (S300). And finally, the composite tape 1 is removed from the area to be protected (S400). However, in FIG. 3, it should be noted that the step S201 can be undertaken before step S200, before and/or after S400 as conditions may require.

With the composite tape 1 disclosed herein during the tinning process in the tinning stove, the paper-plastic composite substrate will not detach under 280° C. for 2 minutes, meanwhile the thickness of the paper substrate can be reduced to decrease tin accumulation at the bonding edge of the composite tape with the printed circuit board.

In addition, the composite structure of the composite tape can be adapted to protection under high temperature and heat conductance delay, such as the partial area protection of a printed circuit board during the tinning process.

In addition, it should be noted that the composite tape can be widely used to the manufacturing field of electrical or electric devices. It can be used in the protective tinning process of the printed circuit board, and also can be used to vacuum plating, or in a transformer and/or a generator, etc., where high temperature insulation is needed.

The description of present invention is only for illustration purpose, and therefore, modifications, alterations and substitutions may be made in these embodiments without departing from the principles and spirit of the invention, the scope of which is defined in the claims and the equivalents thereof.

1. A method of manufacturing a composite tape which is used for producing printed circuit board, comprising:
providing a mold-releasing layer on a first surface of a paper substrate layer;
providing a composite adhesive layer on an opposing second surface of the paper substrate layer, the composite adhesive layer comprising polyurethane adhesive, polyester adhesive, or the mixture thereof;
providing a plastic layer on the composite adhesive layer; and
providing an adhering layer on the plastic layer.

2. The method according to claim 1, wherein the plastic layer is selected from the group consisting of polyethylene terephthalate (PET), polybutylene terephthalate (PBT), polyimide (PI), polyethylene naphthalate (PEN).

3. The method according to claim 1, wherein the paper substrate layer is selected from the group consisting of flat paper, black back paper and crept paper.

4. The method according to claim 1, wherein the mold-releasing layer comprises acrylic acid emulsion or one that can mold release organic silicone pressure sensitive adhesive.

5. The method according to claim 1, wherein the adhering layer comprises organic silicone pressure-sensitive adhesive.

6. The method according to claim 1, wherein the plastic layer can be processed by corona processing.

7. A composite tape used for manufacturing a printed circuit board, comprising:
a paper substrate layer having opposing first and second surfaces;
a mold-releasing layer disposed on the first surface of a paper substrate layer;
a composite adhesive layer disposed on the second surface of the paper substrate layer, the composite adhesive layer comprising polyurethane adhesive, polyester adhesive, or a mixture thereof;
a plastic layer disposed on the composite adhesive layer; and
an adhering layer disposed on the plastic layer.

8. The composite tape according to claim 7, wherein the plastic layer is selected from the group consisting of polyethylene terephthalate (PET), polybutylene terephthalate (PBT), polyimide (PI), polyethylene naphthalate (PEN).

9. The composite tape according to claim 1, wherein the paper substrate layer is selected from the group consisting of flat paper, black back paper and crept paper.

10. The composite tape according to claim 7, wherein the mold-releasing layer comprises acrylic acid emulsion or one that can mold release the organic silicon pressure-sensitive adhesive.

11. The composite tape according to claim 7, wherein the adhering layer comprises organic silicon pressure-sensitive adhesive.

12. The composite tape according to claim 7, wherein the plastic layer can be processed by corona processing.

13. A manufacturing method for a printed circuit board, including:
adhering a composite tape according to claim 7 to an area to be protected on a printed circuit board;
tinning the printed circuit board; and
flatting the printed circuit board taken out under hot air blast.

14. The manufacturing method for a printed circuit board according to claim 13, further comprising a heating and pressurizing step to the composite tape after the adhering step.

15. The manufacturing method for a printed circuit board according to claim 13, further comprising an acid cleaning, water washing, drying and/or grinding step to the printed circuit board after and/or before the tinning step.

16. The manufacturing method for a printed circuit board according to claim 13, wherein, the area to be protected is a gilded area on a surface of the printed circuit board or other area to be covered.

17. The manufacturing method for a printed circuit board according to claim 13, further comprising the step of removing the composite tape from the area to be protected.
